(19) United States
(12) Patent Application Publication
(10) Pub. No.: US 2025/0208026 A1
(43) Pub. Date: Jun. 26, 2025

(54) CONTROLS AND THEIR USE IN ANALYZERS

(71) Applicant: BECKMAN COULTER, INC., Brea, CA (US)

(72) Inventors: Bart WANDERS, Trabuco Canyon, CA (US); Eric GRACE, Deland, FL (US); Jiuliu LU, Miami, FL (US); Bian Qian, Miami, FL (US)

(21) Appl. No.: 18/848,749

(22) PCT Filed: Mar. 11, 2023
(86) PCT No.: PCT/US2023/015038

§ 371 Date: Sep. 19, 2024

Related U.S. Application Data
(60) Provisional application No. 63/318,963, filed on Mar. 11, 2022.

(51) Int. Cl. G01N 15/14; G01N 15/01; G01N 15/1433

(52) U.S. Cl. CPC G01N 15/1468; G01N 15/01; G01N 15/1433; G01N 15/1456; G01N 2015/1472; G01N 2015/1493

(57) ABSTRACT

An analyzer may have its operation validated using control samples which comprise synthetic particles. Such an analyzer be adapted to obtain a representation of a particle from a sample and obtain a classification of the particle which classifies the particle as a type specific to control samples. The analyzer may also be adapted to perform control specific processing on the sample, and to generate an analysis output for the sample based on a result of the control specific processing.

### CROSS REFERENCE TO RELATED APPLICATIONS

This is a PCT International application of, and claims the benefit of priority to, U.S. provisional patent application 63/318,963, filed on Mar. 11, 2023, titled “Synthetic Controls and Their Use in Analyzers,” the disclosure of which is hereby incorporated by reference in its entirety.

### BACKGROUND

Blood cell analysis is a commonly performed medical test for providing an overview of a patient's health status. A blood sample can be drawn from a patient's body and stored in a test tube containing an anticoagulant to prevent clotting. A whole blood sample normally comprises three major classes of blood cells including red blood cells (erythrocytes), white blood cells (leukocytes) and platelets (thrombocytes). Each class can be further divided into subclasses of members. For example, five major types or subclasses of white blood cells (WBCs) have different shapes and functions. White blood cells may include neutrophils, lymphocytes, monocytes, eosinophils, and basophils. There are also subclasses of the red blood cell types. The appearances of particles in a sample may differ according to pathological conditions, cell maturity and other causes. Red blood cell subclasses may include reticulocytes and nucleated red blood cells.

To evaluate and document whether an analyzer is able to effectively perform its tasks, such as, but not limited to, analysis of blood samples, it may be provided with a control sample having known characteristics, and the results of analysis by the analyzer compared with what would be expected based on the control samples' known characteristic(s). However, current approaches to this type of evaluation have many problems. For example, control samples will commonly use cellular products with characteristics that mimic as closely as possible those of cells which may appear in a patient sample. However, procuring such cellular products can be difficult, and, even once procured, such cellular products may have a limited shelf-life and/or may require stabilization, which can alter their characteristics and add both cost and complexity.

Existing control sample technology, furthermore, is based on techniques to indirectly measure parameters of a sample (e.g., via fluorescent measurement, light scatter analysis, or conductivity measurements). However, newer blood analysis technology leverages imaging (e.g., either static imaging or flow imaging). Accordingly, there is a need for improvements in technology which may be used to evaluate and document the function of an analyzer to address one or more issues associated with current practices.

### SUMMARY

Aspects of the present disclosure may be used to validate the performance of analyzers.

In one aspect, a method which comprises providing a sample to an analyzer is disclosed, wherein the analyzer may be adapted to use a camera in analyzing samples. Such a method may also comprise obtaining a representation of a particle from the sample. Such a method may also comprise obtaining a visual representation or an image of a particle from the sample. Such a method may also include obtaining a classification of the particle, wherein the classification classifies the particle as a type specific to control samples. Such a method may also include performing control specific processing on the sample. Such a method may also include generating an analysis output for the sample, wherein the analysis output is based on a result of the control specific processing.

In another aspect, a system may be provided which may comprise a camera, a processor and a non-transitory computer readable medium having stored thereon instructions operable to, when executed by the processor, perform a set of acts. In such a case, the set of acts may comprise obtaining a representation of a particle from a sample and obtaining a classification of the particle from the sample, wherein the classification classifies the particle as a type specific to control samples. The set of acts may also comprise performing control specific processing on the sample. Further, in this aspect, the set of acts may comprise generating an analysis output for the sample, wherein the analysis output is based on a result of the control specific processing. The set of acts may also comprise obtaining a visual representation or an image of a particle from the sample.

In yet another aspect, a non-transitory computer readable medium may be provided which has stored thereon instructions operable to, when executed by a processor, cause an analyzer to perform a set of acts. In such an aspect, the set of acts may comprise obtaining a representation of a particle from a sample and obtaining a classification of the particle from the sample, wherein the classification classifies the particle as a type specific to control samples. The set of acts may also comprise performing control specific processing on the sample. Further, in such an aspect, the set of acts may comprise generating an analysis output for the sample, wherein the analysis output is based on a result of the control specific processing. The set of acts may also comprise obtaining a visual representation or an image of a particle from the sample.

In one aspect, a control sample utilizing control particles is described. In some aspects, the control particles are composed of biological material (e.g., animal-derived cells such as animal derived blood cells, human-derived cells such as human blood cells), synthetic material, or combinations thereof. In some aspects, the control particles are uniquely configured for image analysis. In some aspects, the control particles utilize various combinations of colors, shapes, surface characteristics such as projections or dimples, different sizes, surface detection patterns, internal structures, or surface functionalization.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 is a schematic illustration, partly in section and not to scale, showing operational aspects of an exemplary flowcell which may be used in an analyzer configured to capture and analyze images.

FIG. 2 illustrates an exemplary analysis process.

FIG. 3 illustrates an exemplary classification process.

FIG. 4 illustrates an architecture which can be used in analyzing images and assigning them to particular classes.

FIG. 5 illustrates a processing stage which may be included in classification.

FIG. 6 depicts exemplary images of blood-derived control particles.

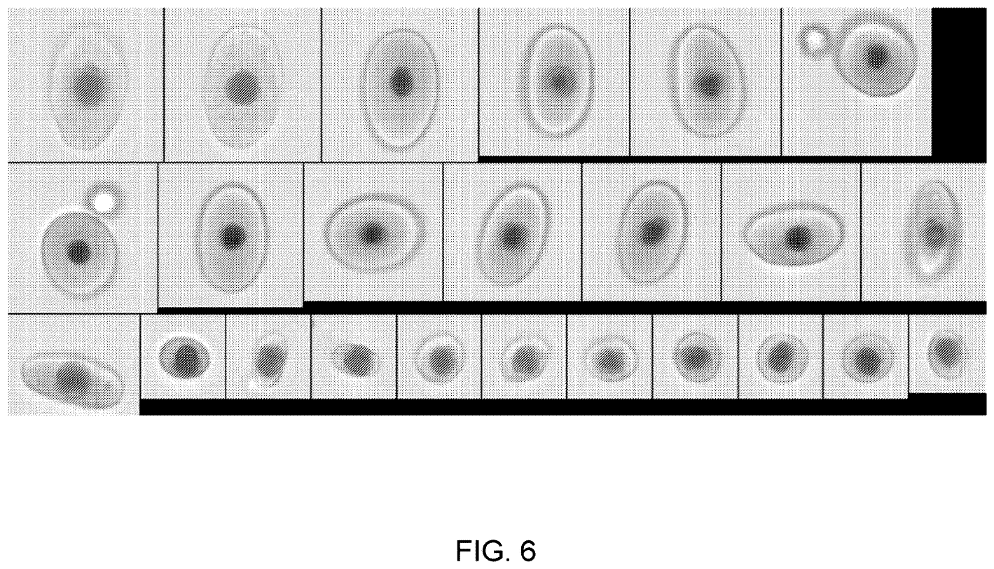

FIG. 7 depicts exemplary images of a combination of control particles, including blood-derived control particles and synthetic control particles.

FIG. 8 depicts examples of blood-derived control particles, along with the blood cell types they can represent.

FIG. 9 depicts a process by which control and sample particles may be classified.

FIG. 10 depicts a process by which control and sample particles may be classified.

FIG. 11 depicts a process by which control and sample particles may be classified.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The present disclosure relates to articles, systems, and methods for evaluating and documenting functionality of analyzers. In some aspects, the analyzers may be visual analyzers comprising processors to facilitate automated conversion and/or analysis of images. Such analyzers may be useful, for example, in characterizing particles in biological fluids, such as detecting and quantifying erythrocytes, reticulocytes, nucleated red blood cells, platelets, and white blood cells, including white blood cell differential counting, categorization and subcategorization and analysis. Other similar uses such as characterizing blood cells from other fluids (serum, bone marrow, lavage fluid, effusions, exudates, cerebrospinal fluid, pleural fluid, peritoneal fluid, and amniotic fluid) are also contemplated.

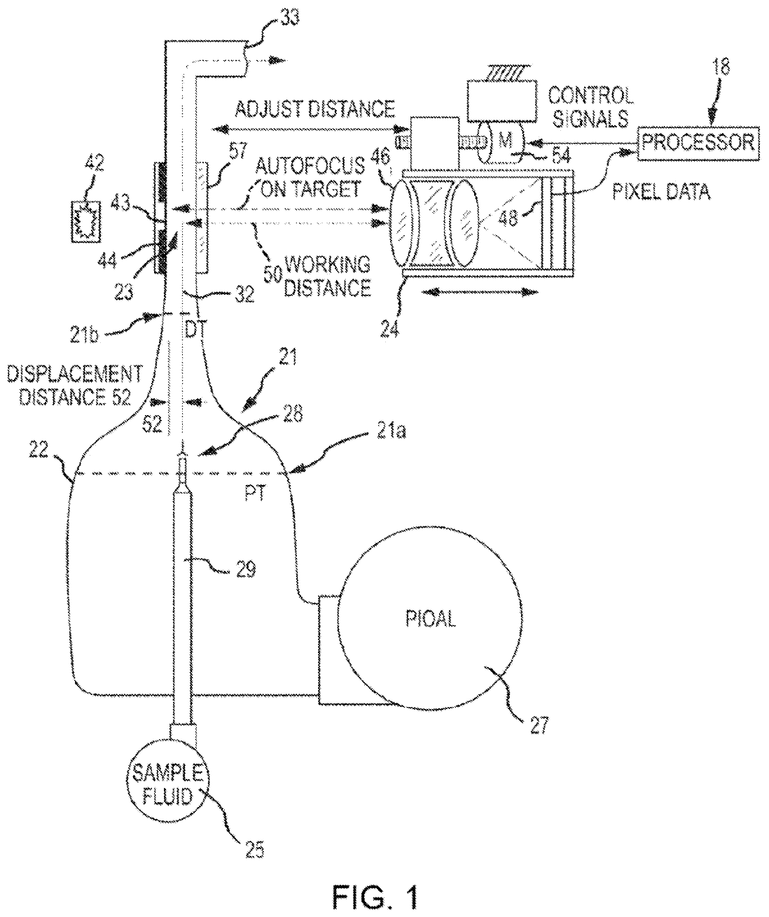

Turning now to the drawings, FIG. 1 schematically shows an exemplary flowcell 22 which may be used in an analyzer for conveying a sample fluid through a viewing zone 23 of a high optical resolution imaging device 24 (e.g., a camera) in a configuration for imaging microscopic particles in a sample flow stream 32 using digital image processing. Flowcell 22 is coupled to a source 25 of sample fluid which may have been subjected to processing, such as contact with a particle contrast agent composition and heating. Flowcell 22 is also coupled to one or more sources 27 of a particle and/or intracellular organelle alignment liquid (PIOAL)/sheath fluid, such as a clear glycerol solution having a viscosity that is greater than the viscosity of the sample fluid, an example of which is disclosed in U.S. Pat. Nos. 9,316,635 and 10,451,612, the disclosures of which are hereby incorporated by reference in their entirety.

The sample fluid is injected through a flattened opening at a distal end 28 of a sample feed tube 29, and into the interior of the flowcell 22 at a point where the PIOAL flow has been substantially established resulting in a stable and symmetric laminar flow of the PIOAL above and below (or on opposing sides of) the ribbon-shaped sample stream. The sample and PIOAL streams may be supplied by precision metering pumps that move the PIOAL with the injected sample fluid along a flowpath that narrows substantially. The PIOAL envelopes and compresses the sample fluid in the zone 21 where the flowpath narrows. Hence, the decrease in flowpath thickness at zone 21 can contribute to a geometric focusing of the sample flow stream 32. The sample flow stream 32 is enveloped and carried along with the PIOAL downstream of the narrowing zone 21, passing in front of, or otherwise through the viewing zone 23 of, the high optical resolution imaging device 24 where images are collected, for example, using a CCD 48. Processor 18 can receive, as input, pixel data from CCD 48. The sample fluid ribbon flows together with the PIOAL to a discharge 33.

As shown here, the narrowing zone 21 can have a proximal flowpath portion 21a having a proximal thickness PT and a distal flowpath portion 21b having a distal thickness DT, such that distal thickness DT is less than proximal thickness PT. The sample fluid can therefore be injected through the distal end 28 of sample tube 29 at a location that is distal to the proximal portion 21a and proximal to the distal portion 21b. Hence, the sample fluid can enter the PIOAL envelope as the PIOAL stream is compressed by the zone 21, wherein the sample fluid injection tube has a distal exit port through which sample fluid is injected into flowing sheath fluid, the distal exit port bounded by the decrease in flowpath size of the flowcell.

The digital high optical resolution imaging device 24 with objective lens 46 is directed along an optical axis that intersects the ribbon-shaped sample flow stream 32. The relative distance between the objective 46 and the flowcell 33 is variable by operation of a motor drive 54, for resolving and collecting a focused digitized image on a photosensor array. Additional information regarding the construction and operation of an exemplary flowcell such as shown in FIG. 1 is provided in U.S. Pat. No. 9,322,752, entitled “Flowcell Systems and Methods for Particle Analysis in Blood Samples,” filed on Mar. 17, 2014, the disclosure of which is hereby incorporated by reference in its entirety.

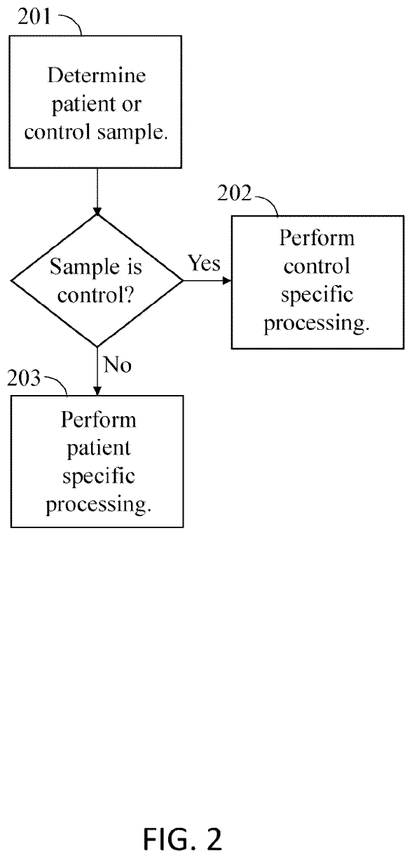

In operation, an analyzer such as an analyzer incorporating a flowcell based imaging system as illustrated in FIG. 1 may analyze images of particles (e.g., cells) in a sample, such as by using a process of the type shown in FIG. 2. Control particles are used to ensure the analyzer is functioning correctly, such that the analyzer is capable of effectively and correctly counting or otherwise determining analyzed particles (e.g., blood cells). In this way, a control particle procedure utilizing control particles is run (e.g., at the start of the day before the analyzer will be used) to ensure the analyzer is working correctly and is capable of counting patient samples (e.g., blood cells) correctly. As will be further disclosed herein, the control particles can utilize whole blood (e.g., derived from human or animal blood), synthetic material, or mixtures thereof.

Initially, in the process of FIG. 2, a determination 201 is made as to whether a sample is a patient sample, such as a blood sample, or a control sample, such as a sample comprising control particles. In this context, it should be understood that a control particle is a particle which represents a known particle and may be used to ensure the analyzer is functioning correctly. For instance, each of a red blood cell (erythrocyte), nucleated red blood cell, platelet (thrombocyte), reticulocyte, and white blood cells (leukocyte) (the white blood cells comprising, at least, neutrophils, lymphocytes, monocytes, eosinophils, basophils, as well as optionally immature granulocytes and blast cells) can have an associated control particle meant to represent the particular particle. Correct identification of the control particle is used to ensure that the analyzer is functioning correctly and can proceed to analyze a blood sample. In one example, if the system counts a correct number or range of control particles, that provides confirmation that the system is functioning correctly and can proceed to run blood samples.

While the examples provided herein generally describe types of analysis which may be performed on whole blood samples, it should be understood that the disclosed technology may be used on analyzers which analyze other types of samples as well. Accordingly, a patient sample may be any biological fluid which contains cells, and a control sample may be a control for types of samples other than blood (both mononucleated and polynucleated), such as bone marrow controls. For example, a patient sample or a control sample may be whole blood, e.g., blood which has not been processed or modified except for the possible addition of an anticoagulant to prevent the blood from clotting, which would complicate flowing the blood through a flowcell for analysis. The sample may be processed, e.g., by dilution or by concentration. In some circumstances, the sample may be from a non-blood body fluid, such as urine, synovial fluid, saliva, bile, cerebrospinal fluid, amniotic fluid, semen, mucus, sputum, lymph, aqueous humour, tears, vaginal secretions, pleural fluid, pericardial fluid, peritoneal fluid, and the like. As with blood, if non-blood body fluids are sampled, the non-blood body fluids may be processed e.g., to achieve a desirable cellular concentration for analysis. A possible advantage of evaluating whole blood may be the relatively large number of cells available for analysis in a relatively small sample. A possible advantage of analyzing non-blood body fluids and/or processed blood may be pre-segregation of certain cells of interest and/or a reduction in the number of cells, because of differences in the types and number of cells that normally occur in different body fluids. A lower number of cells may be helpful, for example, for characterizing individual cells.

In some aspects, the control particles are included in a single control sample (e.g., a single tube containing each of the types of control particles), such that the control sample contains a plurality of types of control particles. Other embodiments can distribute the control particles among various control samples (e.g., 2 or more control samples). In one aspect, a control particle may be provided in a carrier fluid, for example, a carrier fluid that is isotonic to and/or having the same osmolarity, and/or the same pH as that of the biological sample. For example, a control particle may be provided in a carrier fluid that is isotonic to that of the blood sample.

In some aspects, the control particles can be formulated to function with imaging technology (e.g., the system of FIG. 1). As such, the control particles can utilize characteristics suited for imaging in order to provide an image-based representation of the target particle (e.g., various colors, shapes, surface characteristics such as projections, dimples, or combinations thereof, different sizes, surface detection patterns, internal structures, surface functionalization). In some aspects, the control particles utilize some uniquely identifiable parameters which may not directly visually correlate with their target particle (e.g., a control neutrophil may not actually visually represent a neutrophil), but are sufficiently demarcated from other control particle types such that a control process can properly identify a control particle type, and use this information to ensure that an analyzer is functioning correctly.

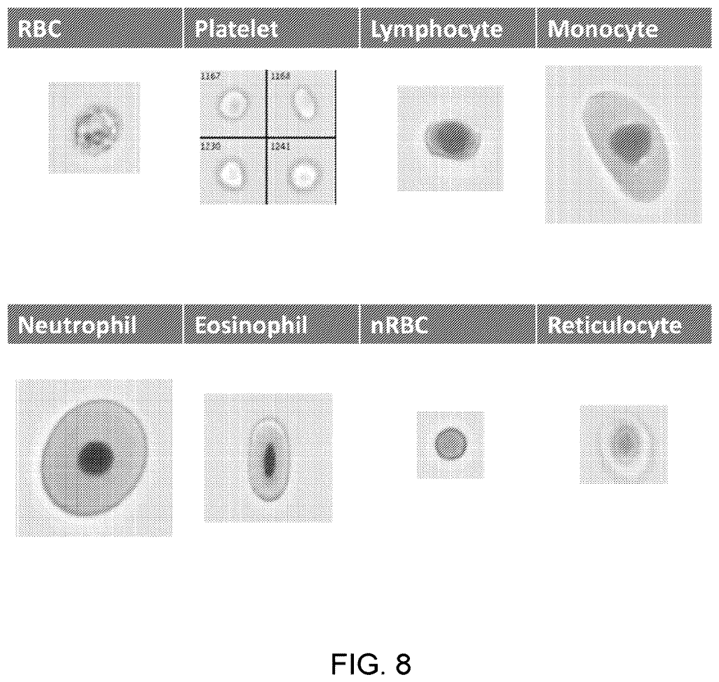

In some aspects, the control particles can be composed of biological material (e.g., animal-derived or human-derived blood cells), synthetic material (e.g., polymers), or a mixture of biological material and synthetic material. In one example, all the control particles in a control sample may utilize animal blood cells which are altered or engineered to provide imaging characteristics (e.g., size, color, and/or shape) meant to reflect the intended particle they are meant to represent. Such alterations or engineering can include utilizing various processes to shrink, expand, re-shape or otherwise alter a physical/imaging characteristic of the cell to reflect the intended particle they are meant to represent. For example, FIG. 8 depicts exemplary images of control particles for biological fluids such as control particles corresponding to red blood cells (RBCs), platelets, lymphocytes, monocytes, neutrophils, cosinophils, nucleated red blood cells (nRBCs), and reticulocytes. In one example, all the control particles in a control sample may utilize synthetic material (e.g., polymers, beads, metals, alloys, hydrogels, combinations thereof) engineered to provide imaging characteristics (e.g., size, color, shape and/or surface characteristics) meant to reflect the intended particle they are meant to represent. For instance, the synthetic material can be engineered to have a size similar to that of the represented particle, or engineered to have an inner colored structure similar to that of a nucleus (e.g., for nucleated controls, such as white blood cell controls and nucleated-red blood cells). In one example, some control particles such as red blood cell control particles, can utilize animal blood cells which are altered in order to provide imaging characteristics meant to reflect the intended particle they are meant to represent (e.g., sized or shaped similar to a red blood cell), while some control particles such as at least a subset of white blood cell control particles can utilize synthetic particles. By way of example, some blood cell types (e.g., white blood cells) contain a nucleus as described above and herein, so a control particle can utilize an internal structure to simulate a nucleus—for instance, a synthetic material can utilize an internal structure that will resemble a nucleus when analyzed by the analyzer.

The control particles may comprise any suitable material. Non-limiting materials that may be used to form the control particles include, but are not limited to, cellulose, silica (silicon dioxide), polymethyl methacrylate) (PMMA)/hydrogel coated materials, melamine (melamine formaldehyde resin), cross-linked agarose, polyvinylacetate (PVA), polystyrene, metals, hydrogels, and combinations thereof. In one aspect, the control particle may comprise a transparent, or semi-transparent material. In this aspect, detection of the control particle may be based, in whole or in part, via detection of the light refracting properties of the control particle. In a further aspect, the control particle may comprise a color, the control particle color being used as a detectible label. In yet further aspects, the control particle may be of a material that is lysable and/or stainable. Upon staining or lysing of the control particle, the detection of the stained and/or lysed particle may further provide information pertaining the sample being measured, including but not limited to calibration or validation of data obtained via the disclosed methods and/or systems.

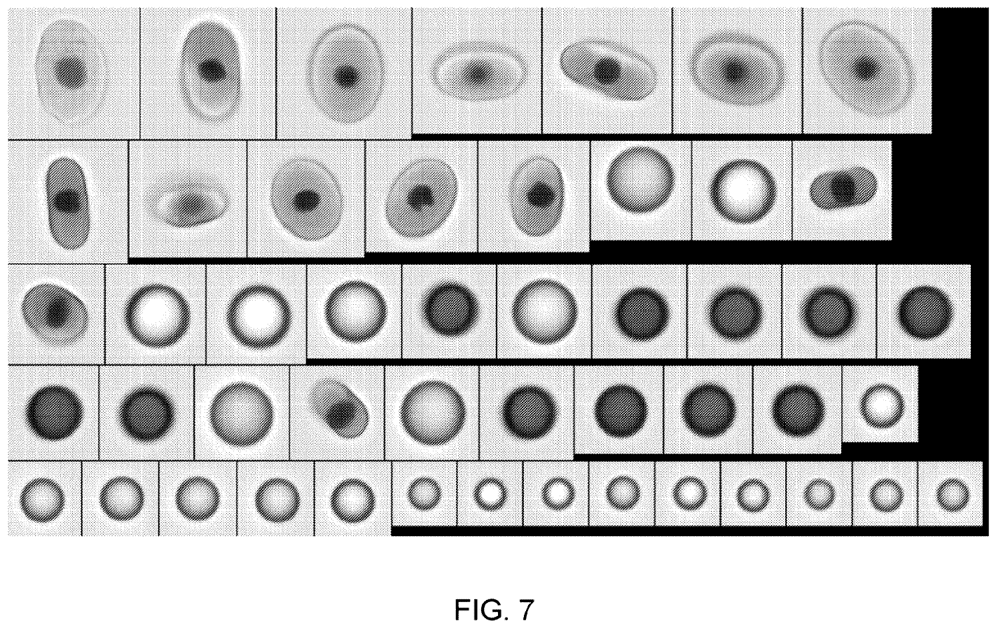

In one aspect, the control particle may be a synthetic bead, for example, a polystyrene microsphere. The control particle may be provided in a control particle composition, the control particle composition comprising synthetic beads of various sizes and colors. For example, as represented in FIG. 7, beads of different colors may be used to represent the particles to be detected in different ways. For example, smaller, red synthetic bead may represent red blood cells, larger red beads may represent cosinophils, smaller, white beads may represent platelets, medium white beads may represent lymph, and larger, blue beads may represent basophils. In this aspect, the size and color of the synthetic bead may be used as characteristics to represent the whole blood cell. One advantage to a synthetic control is extended shelf life compared to controls derived from human or animal blood, which need extensive quality handling procedures and may have a limited use timeframe before degrading.

In one aspect, the control particle may be a size that is from about 1 μm to about 25 μm in diameter, or from about 3 μm to about 20 μm in diameter, or from about 5 μm to about 15 μm in diameter, or from about 10 μm to about 13 μm in diameter. In certain aspects, the control sample may comprise one or more control particles of different sizes. For example, the control sample may comprise control particles that have a size that is comparable to that of a white blood cell, in addition to control particles that have a size that is comparable to that of a red blood cell (e.g., smaller than a white blood cell control). Likewise, the control sample may comprise control particles of a size that does not correspond in size to any expected blood sample components.

In one aspect, the control particle comprises a surface having a detection pattern thereon. In this aspect, the detection pattern may be detected by the instrument (e.g., by recognizing the detection pattern via imaging) and allow for detection or quantification of the control particle. In one aspect, the detection pattern may provide surface characteristics that affect light scatter. In this aspect, the light scatter caused by the control pattern may be detected and may further provide information pertaining the sample being measured.

In further aspects, the control particle may comprise a surface functionalization. For example, the control particle surface may comprise a functionalized particle or DNA molecule. Exemplary groups that may be used to functionalize the control particle include, but are not limited to, mercapto groups, hydroxyl groups, carboxyl groups, disulfide groups, polyvinylalcohol groups, amine groups (primary and secondary ammonium), maleimido groups, tertiary ammonium groups, quaternary ammonium groups, epoxy groups, carboxylsulfonate groups, and octadecyl (Cl 8) groups.

While control particles may be used to establish if an analyzer is functioning correctly (e.g., by correctly distinguishing the number of control particles analyzed), calibration particles may be used to calibrate the analyzer to ensure the analyzer is outputting correct information (e.g., by setting a particular parameter, such as output of numeric channels or electronics configurations). In this way a calibration particle can be used to adjust a parameter of the analyzer to ensure it is correctly analyzing presented specimens, while a control particle may be used to ensure the analyzer is working correctly. By way of the example, if a control sample is run and the analyzer does not read the control particles correctly (e.g., does not read a correct number or range), the data is flagged and an operator can input a calibration particle to adjust the functioning of the machine, then reintroduce a control particle sample to see if the analyzer is now reading the particles correctly. While the description herein has generally focused on a control particle, in some embodiments these attributes can be utilized on a calibration particle as well.

In some embodiments, an analyzer system may use a process such as shown in FIG. 2 to analyze a sample in various ways. As shown in FIG. 2, in some cases an analyzer may obtain representations (e.g., visual representations) of a plurality of particles (e.g., blood cells, in a blood sample, or control particles, in a control sample) and provide those representations to a classifier which had been trained to recognize and classify particles into classes corresponding to either patient samples or control samples. In such a case, the analyzer may determine that the sample is either a patient sample or a control sample through various techniques. For instance, whether a majority of the particle representations were classified as patient sample particles or control sample particles, if a barcode scanning process determined the sample to be that of a patient sample or control sample, or if a software process establishes a particular confidence score threshold is exceeded are all techniques which could be used to determine whether the sample is a patient sample or control sample.

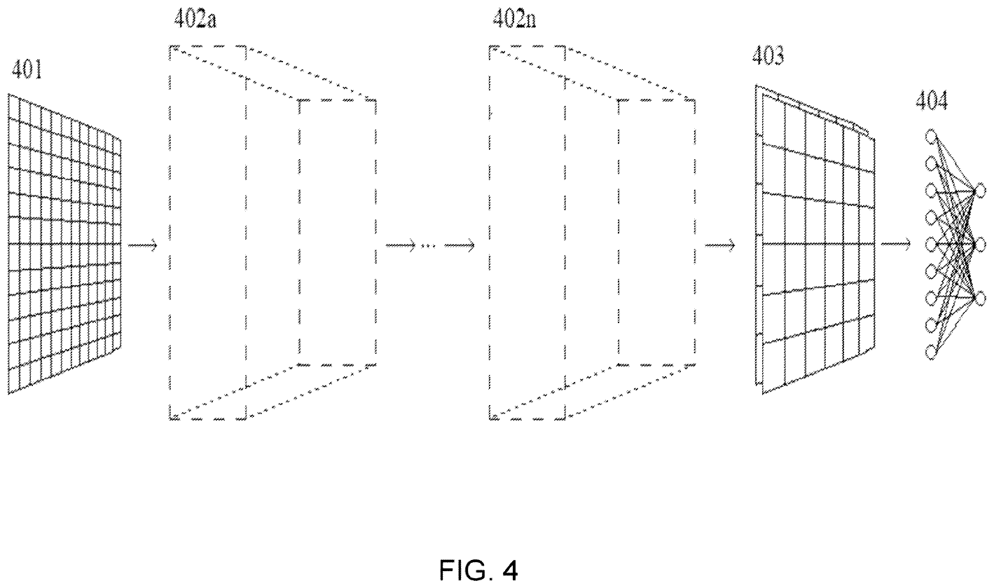

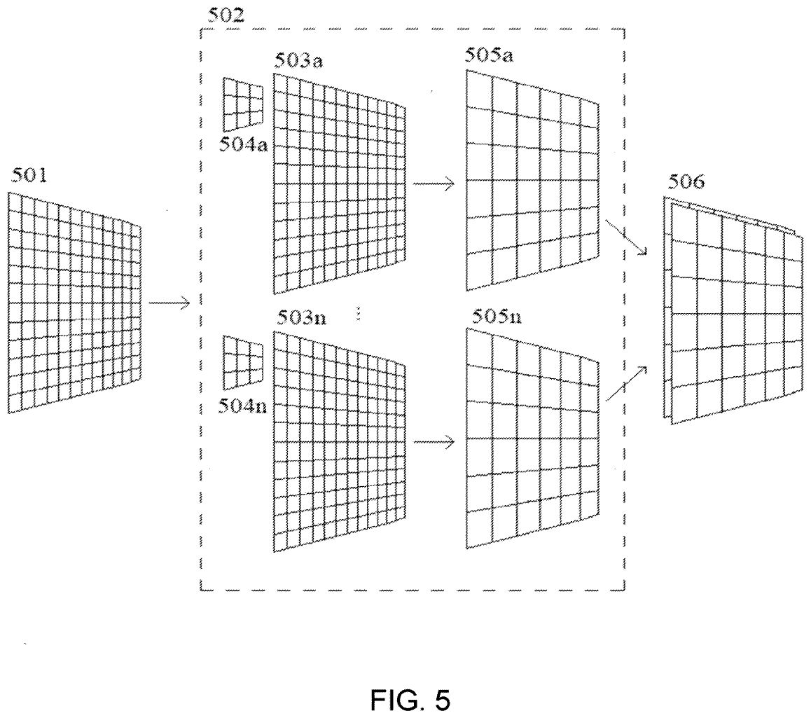

To further illustrate how classifier-based approaches may determine 201 if a sample is a patient sample or a control sample, consider FIG. 4, which shows an architecture which can be used in analyzing images and assigning them to particular classes. In the architecture of FIG. 4, an input image 401 would be analyzed in a series of stages 402a-402n, each of which may be referred to as a “layer,” and which is illustrated in more detail in FIG. 5. As shown in FIG. 5, an input 501 (which, in the initial layer 502a of FIG. 4 would be the input image 401, and otherwise would be the output of the preceding layer) is provided to a layer 502 where it would be processed to generate one or more transformed images 503a-503n. This processing may include convolving the input 501 with a set of filters 504a-504n, each of which would identify a type of feature from the underlying image that would then be captured in that filter's corresponding transformed image. For instance, as a simple example, convolving an image with the filter shown in table 1.

TABLE 1

[−1 −1 −1 ]
[−1 8 −1 ]
[−1 −1 −1 ]

could generate a transformed image capturing the edges from the input 501.

As shown in FIG. 5, in addition to generating transformed images 503a-503n a layer may also generate a pooled image 505a-505n for each of the transformed images 503a-503n. This may be done, for example, by organizing the appropriate transformed image into a set of regions, and then replacing the values in that region with a single value, such as the maximum value for the region or the average of the values for the region. The result would be a pooled image whose resolution would be reduced relative to its corresponding transformed image based on the size of the regions it was split into (e.g., if the transformed image had N×N dimensions, and it was split into 2×2 regions, then the pooled image would have size (N/2)×(N/2)). These pooled images 505a-505n could then be combined into a single output image 506, in which each of the pooled images 505a-505n is treated as a separate channel in the output image 506. This output image 506 can then be provided as input to the next layer as shown in FIG. 4.

Returning to the discussion of FIG. 4, after a final output image 403 has been created through the various stages 402a-402n of processing, the final output image 403 could be provided as input to a neural network 404. This may be done, for example, by providing the value of each channel of each pixel in the output image 403 to an input node of a densely connected single layer network. The output of the neural network 404 could then be treated as a classification of the image in a class indicating corresponding to either a control sample or a patient sample. For example, in some cases, a neural network may have a plurality of output nodes, with each node corresponding to a possible classification (e.g., red blood cell particle in a patient sample, which by way of example may be identified as rbc_blood where the blood label suffix is indicative of a patient blood sample; red blood cell particle in a control sample, which by way of example may be identified as rbc_control where the control label suffix is indicative of a control sample; etc.), in which case the node with the highest value could be treated as the appropriate classification for the image. Please note, the _blood and _control designations are provided as exemplary labels that are indicative of sample type, any variety of designations can be used (e.g., _bl, _blood, _b, _control, _ctrl, _c, etc.).

Alternatively, in some cases, there may be only a single output node, and the value of the output node may be treated as indicating if the image should be treated as depicting a particle from a control sample or a patient sample (e.g., if the value of the output node was above a threshold, then the image could be treated as depicting a particle from a control sample, while if the value was below the threshold, then the image could be treated as depicting a particle from a patient sample). In either case, a classifier such as illustrated in FIGS. 4 and 5 could be trained to make its determinations using a training method in which the classifier was requested to classify human labeled images representative of the types of particles it would be used to classify in production. In such a method, where the classifier's classification differed from the human label, an error value could be determined (e.g., using cross entropy loss in the case of a classifier having multiple output nodes), and that error could be back propagated through the nodes of the neural network and the classifier's layers so that, on future iterations, the classifier's classifications would be expected to be closer to the labels assigned by a human annotator.

Of course, it should be understood that classifiers such as described above in the context of FIGS. 4 and 5 are intended to be illustrative only, and should not be treated as implying limitations on how classifications could be made in various implementations of the disclosed technology. For example, in some cases, classifications of a particle as being indicative of a control sample or a patient sample may be made based on features of particles, with the features of a particular particle being compared with thresholds or evaluated for other characteristics associated with particular particle types. Such features may include, without limitation: area of a particle (e.g., a cell) depicted in an image, intensity value of pixels depicting the particle (e.g., as may be determined by removing the background via thresholding, and taking the 1 value of pixels represented in the L*a*b color space), mean of intensity values of pixels on the edge of a particle, mean of intensity values of pixels within a defined distance of the edge of a particle, color of pixels depicting a particle, etc. Determinations of a type for a particle may also be made based on combinations of features, such as the result of dividing blue and red values of pixels depicting a particle in RGB color space. In a cell-by-cell/particle-by-particle classification, in one example, each particle would receive a label (e.g. rbc_blood for a patient red blood cell, or rbc_control for a red blood cell control), where the summation of the labelled cells are pooled to determine a sample type (e.g., via majority voting, or a confidence score assessment).

Additionally, in some cases, determinations of particle type may utilize feature-based assessment, but the determination may be made on a population basis, rather than based on characteristics of particles considered individually. For example, in some cases, particles could be clustered in a n-dimensional space where the dimensions are particle characteristics, and the particles could be classified based on the relationships of their clusters to the other clusters in the space (e.g., a particle could be classified a white blood cell if it belonged to a cluster of particles with relatively high darkness values and blueness-redness values, and may subsequently be further classified as a type of white blood cell based on further characteristics such as a number of dark blue granules surrounding the nucleus). In one example, the determination of cell types at a population level is done at roughly the same time for each cell, where once the population pool and associated label for each cell is identified, a majority voting or confidence thresholding system can then be applied at the population level and used to establish the sample type (e.g., either a patient sample or a control sample). Accordingly, the preceding discussion of how particles may be classified should be understood as being illustrative only, and should not be treated as implying limitations on the scope of protection provided by this document.

Information on feature based and population-based classifiers are disclosed in U.S. Prov. App No. 63/434,658 and U.S. Pat. No. 11,403,751, the contents of which are hereby incorporated by reference in their entirety.

Additional examples can utilize a plurality of particle classifier types, where each classifier is making a particle assessment on a particle-by-particle basis which is used to help establish whether the sample is a patient sample or a control sample (e.g., if a majority of particles are of a patient blood type or of a control type, or if a particular confidence for the sample type is established). There can be a further agreement process among the plurality of classifiers to establish a label for each cell type, or to establish a label for the sample itself (e.g., as being a patient sample or a control sample). The particle classifiers can be a plurality of feature or population-based classifier, a plurality of neural-network based classifiers, or a combination therein. In one embodiment, a majority determination among a plurality of classifiers can be used to assign a cell label. In one embodiment, one of the classifiers can be weighted such that if that particular classifier exceeds a particular confidence score threshold for a particular label, then that label is assigned. Additional information on voting or final label determination for a plurality of classifiers can be found in U.S. Prov. App. No. 63/434,798, the contents of which are hereby incorporated by reference in their entirety.

In an aspect following a method such as shown in FIG. 2, once a sample had been determined 201 to be either a patient sample or a control sample, that determination may be used to perform processing corresponding to the determined sample type. For example, a determination that a sample is a control sample may trigger a unique performance 202 of a procedure that is run specifically for control sample/control particle analysis (e.g., a control sample procedure or a control sample run mode). For example, if a sample is identified as a control sample based on classifying a majority of particles as control particles, then the control specific processing may include reclassifying any particles which were not initially classified as control particles using a control particle specific classifier, or using data correlating control particle classifications to patient sample classifications (e.g., reclassifying particles which were added to a class for red blood cells in patient samples into a class for red blood cells in control samples, etc.). Alternatively, if a sample is identified as a control sample based on classifying a majority of particles as control particles, then any particles classified as blood particles instead of control particles can be disregarded. Similarly, if the sample was determined 201 to be a patient sample, the method of FIG. 2 may perform 203 patient specific processing, such as classifying particles from the sample using a patient sample specific classifier (e.g., a convolutional neural network based classifier as described above in the context of FIGS. 4 and 5, or a feature based classifier such as described above), or reclassifying particles which had originally be classified as control particles in a manner similar to that described above for performing 202 control specific processing.

Of course, variations on the approaches described above are also possible. For example, in some cases, if a sample is identified as a control sample based on classifying a majority of particles as control particles using a relatively coarse classifier, then the control specific processing may be to process the particle images (which may be all particle images, or may be only the particle images identified as control particles, with other images being classified as junk or unknown), using a more fine grained classifier. For example, initially cell image may be classified into classes for particles identified as nucleated cells in a control sample, particles identified as red blood cells in a sample, particles identified as reticulocytes in a control sample, junk particles, particles identified as nucleated cells in a patient sample, particles identified as red blood cells in a patient sample, or particles identified as reticulocytes in a patient sample, and then, once the sample is classified as either a control sample or a patient sample, it may be classified using a more fine grained classifier (e.g., a control particle classifier which classifies particles into classes of control eosinophils, control monocytes, control lymphocytes, control neutrophils, control nucleated red blood cells, control non-nucleated red blood cells, control reticulocytes and junk). Other types of processing which is specific to patient or control samples may also be performed in some cases, such as providing reports documenting validation of the analyzer's functionality in the case of a control sample, or providing the results of tests for identifying disorders in the case of a patient sample. As another alternative, in some cases all cell images may be classified with a single classifier which was trained to classify the cells into control or patient sample classes as appropriate, and, once it had been determined whether the sample was a control or a patient sample, the type specific processing may be for images which had been added to classes that didn't match that type of sample to be reclassified into JUNK or UNKNOWN classes. Accordingly, the descriptions above of classification approaches and patient/control specific processing should be understood as being illustrative only, and should not be treated as implying limits on the scope of protection provided by this document or any related document.

Other uses of image-based analyzers and/or classifications are also possible. For example, in some embodiments, an image-based system utilizes a classifier to classify the type of particle analyzed (e.g., classify a blood particle as either a red blood cell, nucleated red blood cell, reticulocyte, platelet, neutrophil, lymphocytes, monocytes, eosinophils, or basophil). Neutrophils, lymphocytes, monocytes, eosinophils, and basophil are all white blood cells so differentiating among these five groups is known as a 5-part differential, though this can be expanded to a 6-part differential by including either blasts or immature granulocytes, or a 7-part differential by including both blasts and immature granulocytes.

The image-based system can utilize a classifier to classify the particular particle of interest. The classifier may utilize a data structure such as a decision tree classifier, neural network, or Bayesian classifier trained to recognize the various subpopulations using training data comprising particle images which have been annotated with the appropriate subpopulation type. The classifier can be used to classify or label a specific particle type (e.g., using control and patient sample classes of the types described above).

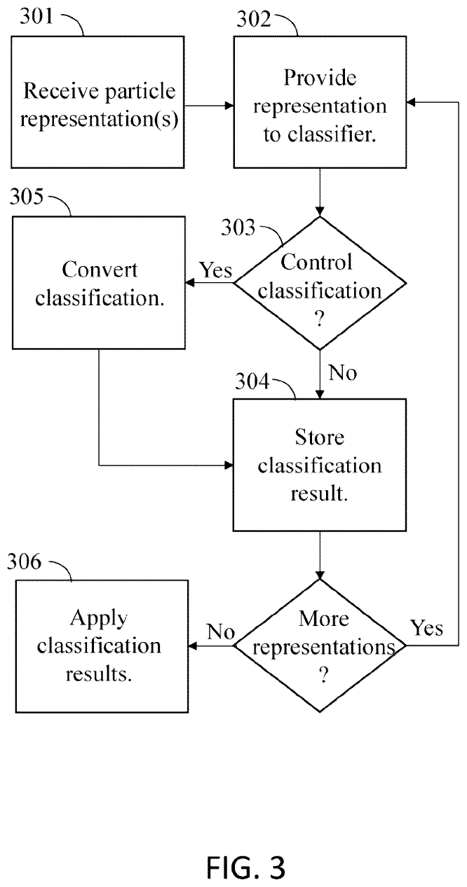

While, as noted above, a type determination may be made and then corresponding processing for a sample as a whole may be applied, it is also possible to implement the disclosed technology to make a type determination and apply appropriate processing on a particle by particle basis. An example of a method which could be used to implement this type of approach is provided in FIG. 3. Initially, in the process of FIG. 3, one or more representations of particles (e.g., cells) from a sample would be received 301. This may comprise, for example, a processor receiving one or more images which each include representations of a plurality of particles. These representations may then be isolated (e.g., using a cell isolation algorithm, such as an algorithm which thresholds an image captured by a flow cell based system to identify portions of the image which do and do not represent a cell) and stored for further processing in a memory of the analyzer. Alternatively, receiving 301 representations of particle(s) may comprise a processor receiving a plurality of images, each of which comprises a representation of only a single particle (e.g., a single cell) which may then be subjected to further image processing (e.g., thresholding to remove background portions of the image) or subjected to substantive analysis such as the classification discussed below.

In the process of FIG. 3, after one or more particle representations had been received 301, each of those representations may be processed by performing steps including providing 302 it as input to a classifier. To illustrate how this may take place, consider a scenario in which the analyzer is used to perform a five-part differential, in which white blood cells in a sample are classified into subpopulations of neutrophils, lymphocytes, monocytes, eosinophils, and basophils. In such a case, to facilitate the five-part differential analysis, prior to deployment of the analyzer a data structure such as a decision tree classifier, neural network, or Bayesian classifier may be trained to recognize the various subpopulations using training data comprising particle images which have been annotated with the appropriate subpopulation type. A copy of this trained data structure may then be stored on a memory of the analyzer prior to it being put to use, and the step of providing 302 the representation to the classifier may be performed using representation as an input for being processed using the data structure.

After a classifier has assigned a class to a particular representation, in a process such as shown in FIG. 3, a determination 303 may be made of whether the classification is of a particle which is specific to a control sample. To illustrate what this type of determination may entail, consider the case of a control sample that may contain synthetic particles (control particles made from synthetic material, such as polymers). The control sample may be a composition comprising control particles, the control particles having various combinations of a predetermined size and shape, detectable surface markings, colors, internal features. In one aspect, the features described above can be used as reference marks such that the control particle can resemble its analogue blood particle (e.g., a control red blood cell having a shape similar to an actual red blood cell, a control neutrophil having an inner region having a shape and color similar to a nucleus of an actual neutrophil, a control granulocyte having granular features similar to those of an actual granulocyte).

To accommodate a synthetic control sample such as described above, an analyzer may be provided with a classifier that is trained not only to recognize classes for particles such as would be included in a patient sample (e.g., blood cells/blood particles) but also to include classes for synthetic particles from a control sample. For example, an analyzer that would be used to perform a five part differential on patient samples and to be validated using a control comprising synthetic particles may be provided with a classifier that could classify particles into neutrophils, lymphocytes, monocytes, eosinophils, and basophils (i.e., types of cells which could be expected to be present in a patient sample) or into one or more control particle types (i.e., types of synthetic particles that could be expected to be present in a control sample). In such a case, the analyzer could be configured with data indicating which of the classifications corresponded to synthetic particles that would not be expected to be present in a control sample, and the determination 303 of whether a particle was classified using a control classification could be made by comparing the classification for that particle with the analyzer's classification data.

In a process such as shown in FIG. 3, if a particle was classified in a class which was not specific to a control (e.g., a class for a type of real blood, such as a red blood cell) then that classification could be stored 304 in a memory of the analyzer for subsequent processing. Alternatively, if the particle was classified in a class which was specific to a control (e.g., a control red blood cell), then its classification could be converted 305 to a classification for a corresponding particle type which would be expected to be included in a patient sample. For example, in a synthetic control sample which includes a synthetic neutrophil control particle, an analyzer may be configured to treat a particle in that class as having been classified as a neutrophil, and similar types of conversions may be performed for each of the other types of synthetic particles that would be expected to be present in a control sample but not in a patient sample. The converted classifications could then be stored 304, such as by incrementing a counter for the converted classification (e.g., a neutrophil counter) as if the particle had originally been classified using a class that would be expected to be present in a patient sample. Finally, after classification of particles from the sample was complete, the results of that classification could be applied 306, such as by outputting the numbers of particles assigned to each of the relevant classes. This information may then be used for various purposes, such as for the diagnosis or treatment of a condition (if the sample was a patient sample). However, other applications are also possible. For example, results of a process such as shown in FIG. 3 may be used to validate an analyzer's functionality by comparing the actual classification results with expected classification results if the sample which had been analyzed was a control sample. Accordingly, the above description of various applications of the process of FIG. 3, and of how that process could be performed using representations of particles from patient or control samples, should be understood as being illustrative only, and should not be treated as limiting.

It should be understood that, in addition to there being the potential for variations on how the output of a process such as shown in FIG. 3 could be applied, variations are also possible in how a process such as shown in FIG. 3 may be performed. For example, in some cases, storing 304 a classification result may be performed differently depending on whether the relevant particle was classified in a control class or a class for a particle which would be expected to be in a patient sample. For instance, in some cases, when a classification result is stored for a particle which was originally classified in a control class, data such as a flag or counter may be used to reflect that particle's original classification, even though it may be treated as belonging to another class after conversion 305. Similarly, while the above examples illustrated how the disclosed technology may be used in the context of classification for a five-part white blood cell differential, the disclosed technology may be used in other contexts as well. For example, in some cases, a control sample may be used to validate aspects of an analyzer such as its ability to properly stain particles in a sample, or to properly perform tasks other than five-part differentials (e.g., generating a red blood cell count, performing six and/or seven part white blood cell differentials) or generating other types of information regarding a sample (e.g., reporting mean platelet volume). In each case, the types of approaches described above may be used, with control samples potentially including particles which could be detected as being different from particles that would be included in a patient sample with appropriate processing performed based on this determination. Accordingly, the above description of variations on processing, like the description of FIGS. 2 and 3 and the associated text, should be understood as being illustrative only, and should not be treated as limiting.

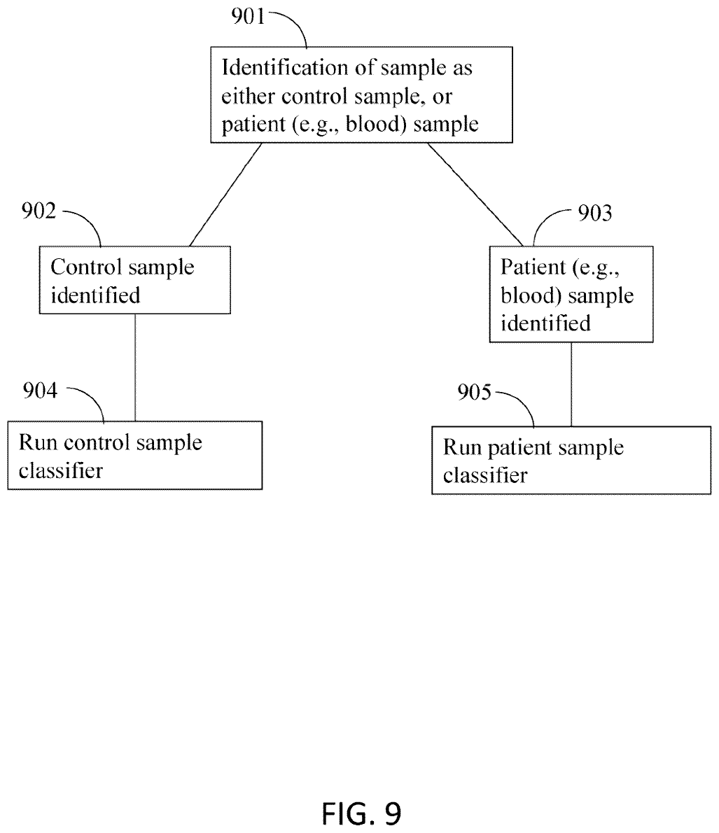

To further illustrate how the disclosed technology may potentially be applied, consider FIGS. 9-11, which depict processes by which control particles and patient particles (e.g., blood) may be classified. In the process depicted in FIG. 9, a routine is run to identify 901 whether the sample is a control sample or a patient sample. This may be done in various ways. In one example, by taking a subset of images captured of particles in that sample, classifying them as control or patient sample particles using a classifier trained for that purpose, and then identifying the sample as a control or patient sample based on how the majority of particles from the subset of images were classified. In another example, by establishing a confidence score in the sample assessment and using that to establish the sample type. In another example, a barcode scan of the sample alerts software on the system to determine if the barcode is indicative of a control sample or a patient sample. After this identification 901 of the sample as a control sample or a patient sample, either all of, or a subset of (e.g., only the particles associated with control sample classes if the sample was identified as a control sample, or only the particles associated with patient sample classes if the sample was identified as a patient sample), the particles associated with the identified sample type would themselves be identified 902 903. For example, the remainder of particles that had not previously been classified could be classified as either control or patient sample particles, or the entire sample could be re-run and classified, and the particles which were placed into a class for the identified 901 sample type could be flagged for further processing. A classifier which was specialized for classifying particles in a control sample or a sample of blood or other patient body fluid could then be run 904 905 on particles identified 902 903 as belonging to classes associated with the identified 901 sample type. As shown in FIG. 9, a classifier which is specialized for classifying particles in a control sample may be configured to classify particles into classes for specific control particle types, such as red blood cell equivalents in a control sample (e.g., rbc_control), platelet equivalents in a control sample (e.g., plt_control), neutrophil equivalents in a control sample (e.g., neutro_control), etc. Similarly, a classifier that is specialized for classifying particles in a blood or other body fluid sample may be configured to classify particles into classes for specific blood particle types, such as red blood cells (e.g., rbc_blood), platelets (e.g., plt_blood), and neutrophils (e.g., neutro_blood). For any particles that were misclassified in the first step where a sample type assessment is made, the particles can later be reclassified, or can be disregarded (e.g., if during the assessment step 901, patient particles are counted where step 902 then indicates the sample is a control sample, the patient particles can be reclassified as control particles [e.g., rbc_blood changed to rbc_control] or the _blood labelled particles can be disregarded entirely). The relevant counts can then be provided to the user (e.g., on a screen display). It should be noted though, that the specific classes and class names indicated in FIG. 9 and mentioned above are provided for the sake of illustration only, and that other names for either control or patient sample particles may be used in various embodiments implemented based on this disclosure.

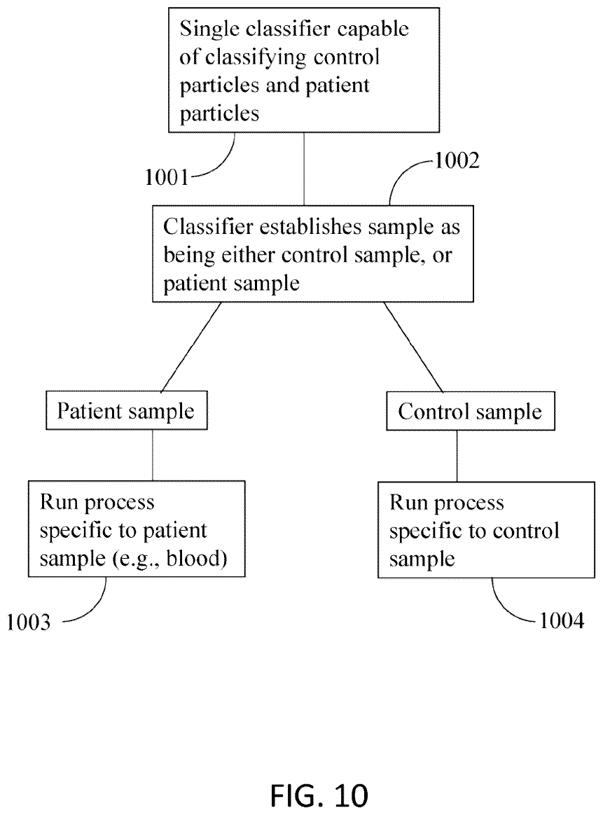

FIG. 10 depicts a process which is similar to that depicted in FIG. 9. Initially, in the process of FIG. 10, representations (e.g., images) of particles in a sample are classified 1001 with a classifier which is trained to place particles into classes corresponding to control samples (a control particle part) and to place particles into classes corresponding to samples of blood or other body fluid (a blood sample part). A determination 1002 could then be made of whether the sample is a control sample or patient sample (e.g., if a majority of particles were classified in classes associated with control samples- or were classified in classes associated with blood or other body fluid samples, or a confidence score classifies the sample as a patient sample or a control sample). As indicated in FIG. 10, these classes may have labels such as neutrophil_blood and neutrophil_control, though those labels are exemplary only, and different labels may be used in different embodiments. Then, depending on whether the majority was of particles which would be expected in blood or other body fluid, or of particles which would be expected in control samples, processes specific to the particles which would be identified in those types of samples could be run 1003 1004. For example, particles identified as associated with control sample classes could be classified with a specialized control classifier, or particles identified as associated with classes for blood or other body fluid samples could be classified with a classifier specialized for blood or other body fluid samples. Additionally, particles which were classified by the initial classifier 1001 as belonging to classes associated with the sample type which were not in the majority could either be reclassified (e.g., using a specialized classifier, or automatically reclassified for instance from rbc_blood to rbc_control or from plt_blood to plt_control if it is determined that it's a control sample), or could be discarded. The relevant counts can then be provided to the user (e.g., on a screen display).

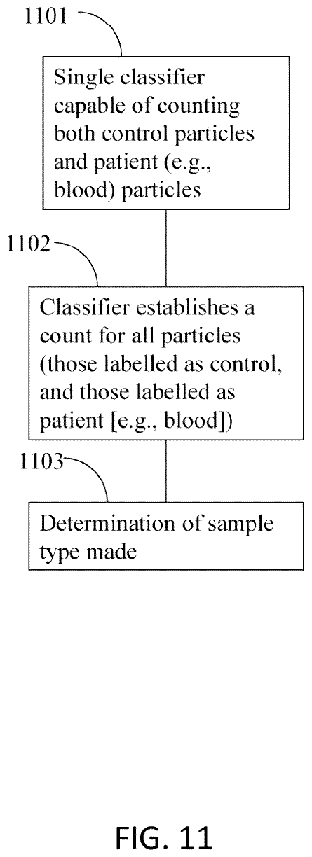

FIG. 11 also depicts another process which can be used to classify particles in a sample. In the process of FIG. 11, initially, representations (e.g., images) of particles in a sample could be classified 1101 using a single classifier which was trained to classify particles which were included in control samples as well as to classify particles included in samples of blood or other body fluid. These classifications (which may be represented by the labels shown in FIG. 11, or may be represented using other labels, depending on the implementation) could then be used to get a total count 1102 of all types of particles in the sample using the classes assigned in the initial classification 1101. Finally, a determination 1103 is made whether the sample is a control sample or a patient (e.g., blood) sample based on the count data (e.g., depending on whether the majority of particles were assigned to classes associated with control samples- or whether the majority of particles were assigned to classes associated with blood or other body fluid samples, or based on a confidence score associated with the labelling or count). Any particles whose labels are incompatible with the sample type determination can then be relabeled (e.g., rbc_blood or plt_blood reclassified as rbc_control or plt_control if it is determined that the sample is a control sample), or discarded. The relevant counts can then be provided to the user (e.g., on a screen display).

It should be understood that, while FIGS. 9-11 illustrated variations on processes which may be performed based on this disclosure, those are not the only variations which may exist between systems or methods implemented based on this disclosure. As another example of a type of variation which may exist between implementations, consider the types of representations which may be used for particles in control or body fluid samples. In some cases, rather than, or in addition to, visual representations, particle representations may comprise using volume, conductivity and light scatter (VCS) characteristics. In such a case, control particles, rather than (or in addition to) having visual characteristics corresponding to blood or other body fluid particles, may have VCS characteristics similar to the blood or other body fluid particles they represent. For example, a control eosin particle may have VCS parameters similar, but not necessarily identical to, blood Eosin, sufficient to allow for imaging to distinguish the particles via imaging. In one aspect, the control particles may be provided in a control particle composition comprising control particles that are engineered to have fluorescence or optical light scatter characteristics similar to the represented particle. In one aspect, the control particles may be provided in a control particle composition comprising control particles engineered to have characteristics similar to the represented particle across a plurality of detection formats (e.g., imaging and VCS, or imaging and fluorescence/light scatter).

As another example of a type of variation which may be implemented in some cases, consider how the determination may be made as to whether a sample is a control sample or a sample of blood or another body fluid. While this determination may be made using approaches such as majority voting based on classifications of representations, it may also be determined in other ways, such as by a user scanning a barcode on a control sample which indicates to the system that a control sample will be run. For instance, the control sample can have a particular barcode label or a particular encryption which analyzer software may identify as being indicative of a control sample. In such a case, a sample may be identified as a control or body fluid sample using a barcode or similar type of data in methods such as shown in FIGS. 2, 3, and 9-11, and this identification may be used in processing in the same manner as the other approaches to determining sample type described previously. Combined approaches are also possible. For example, a system implemented based on this disclosure may provisionally determine that a sample is a patient sample or a control sample based on a barcode scanned by a user, and may then confirm that determination using particle classifications. Additional variations, such as implementations of a method such as shown in FIG. 2, 3 or 9-11 which determined whether a sample was a control sample or a patient sample using a threshold other than majority, such as requiring a supermajority (e.g., 66%, 75%, 80%, 90%, 95%, or 99%) of particles being classified into classes associated with a particular sample type, and flagging the sample if it was not possible to meet that super-majority threshold. It is also possible that confidence levels may be used when establishing the type of a sample or particle. For example, in a case where a particle is classified or a group of particles are classified into a particular class with a confidence below a threshold (e.g., as shown using a Softmax function on the outputs of a neural network based classifier such as shown in FIGS. 4 and 5), the particle/particles may be flagged for further review, with a sample only being classified as either a control or body fluid sample if a threshold requirement (e.g., majority classification) was met with a requisite level of confidence. Other variations are possible, such as a plurality score where a majority score cannot be established (e.g., in scenarios involving a control particle label, a patient particle label, and an unidentified or junk label). Other variations are also possible and will be immediately apparent to one of skill in the art in light of this disclosure. Accordingly, the preceding discussion of approaches to classification of particles and/or samples should be understood as being illustrative only, and should not be treated as limiting.

As a further illustration of potential implementations and applications of the disclosed technology, the following examples are provided of non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A system for cell classification comprising: a camera; a processor; and a non-transitory computer readable medium having stored thereon instructions operable to, when executed by the processor, perform a set of acts comprising: obtaining a representation of a particle from a sample; and obtaining a classification of the particle, wherein the classification classifies the particle as a type specific to control samples.

### Example 2

The system of example 1, wherein the set of acts comprises: performing control specific processing on the sample; and generating an analysis output for the sample, wherein the analysis output is based on a result of the control specific processing.

### Example 3

The system of example 2, wherein the control specific processing comprises, based on the classification of the particle, obtaining a second classification of the particle; the second classification of the particle is a classification as a type which is not specific to control samples; and generating the analysis output for the sample comprises generating the analysis output based on the second classification of the particle.

### Example 4

The system of example 3, wherein the type which is specific to control samples is a synthetic particle type; and the type which is not specific to control samples is a blood cell type.

### Example 5

The system of example 4, wherein the blood cell type is selected from: neutrophils; lymphocytes; monocytes; eosinophils; and basophils.

### Example 6

The system of example 5, wherein the analysis output is selected from: a five-part differential output, a six part differential output, and a seven part differential output.

### Example 7

The system of example 4, wherein the blood cell type is selected from: red blood cells; nucleated red blood cells; reticulocytes; and platelets.

### Example 8

The system of any of examples 1-7, wherein the representation of the particle from the sample is an image of the particle from the sample.

### Example 9

The system of example 8, wherein obtaining the representation of the particle from the sample comprises: using a flowcell to convey a portion of the sample comprising the particle through a viewing zone of the camera; and using the camera to capture to capture the image of the particle when the particle in the viewing zone of the camera.

### Example 10

The system of example 9, wherein using the flowcell to convey the portion of the sample through the viewing zone of the camera comprises enveloping the portion of the sample comprising the particle in sheath fluid which carries the particle in a flow stream through a narrowing zone of the flowcell to the viewing zone of the camera.

### Example 11

The system of any of examples 1-10, wherein: obtaining the classification of the particle is performed using a first classifier, wherein the first classifier is configured to classify particles from control samples into types specific to control samples and to classify particles from patient samples into types which are not specific to control samples; the set of acts comprises: for each of a plurality of additional particles from the sample: obtaining a representation of that particle; and obtaining a classification of that particle using the first classifier; and determining that the sample is a control sample based on a majority of classifications obtained for particles from the sample classifying those particles into types specific to control samples; and the control specific processing is performed on the sample based on determining that the sample is a control sample.

### Example 12

The system of any of examples 1-11, wherein the control specific processing comprises classifying a set of representations of particles from the sample using a classifier which is operable only to classify particles into types which are specific to control samples.

### Example 13

The system of any of examples 1-12, wherein the set of acts comprises identifying the sample as a control sample based on the classification of the particle.

### Example 14

A method for validating performance of an analyzer, the method comprising: providing a sample to an analyzer, wherein the analyzer is adapted to use a camera in analyzing samples; obtaining a representation of a particle from the sample; and obtaining a classification of the particle, wherein the classification classifies the particle as a type specific to control samples; performing control specific processing on the sample.

### Example 15

The method of example 14, wherein the method comprises generating an analysis output for the sample, wherein the analysis output is based on a result of the control specific processing.

### Example 16

The method of example 15, wherein: the control specific processing comprises, based on the classification of the particle, obtaining a second classification of the particle; the second classification of the particle is a classification as a type which is not specific to control samples; and generating the analysis output for the sample comprises generating the analysis output based on the second classification of the particle.

### Example 17

The method of example 16, wherein: the type which is specific to control samples is a synthetic particle type; and the type which is not specific to control samples is a blood cell type.

### Example 18

The method of example 17, wherein the blood cell type is selected from: neutrophils; lymphocytes; monocytes; eosinophils; and basophils.

### Example 19

The method of example 17, wherein the blood cell type is selected from: red blood cells; nucleated red blood cells; reticulocytes; and platelets.

### Example 20

The method of any of examples 15-18, wherein the analysis output is selected from: a five-part differential output, a six part differential output, and a seven part differential output.

### Example 21

The method of any of examples 14-20, wherein the sample comprises the particle in a carrier fluid.

### Example 22

The method of example 21, wherein the particle is configured to represent a blood cell type.

### Example 23

The method of example 21, wherein the particle comprises one or more detectable features selected from size, light reflecting property, color, surface detection pattern, internal structures and surface functionalization.

### Example 24

The method of any of examples 14-23, wherein obtaining the classification of the particle is performed using a first classifier, wherein the first classifier is configured to classify particles from control samples into types specific to control samples and to classify particles from patient samples into types which are not specific to control samples; the method comprises: for each of a plurality of additional particles from the sample: obtaining a representation of that particle; and obtaining a classification of that particle using the first classifier; and determining that the sample is a control sample based on a majority of classifications obtained for particles from the sample classifying those particles into types specific to control samples; and the control specific processing is performed on the sample based on determining that the sample is a control sample.

### Example 25

The method of any of examples 15-24, wherein the control specific processing comprises classifying a set of representations of particles from the sample using a classifier which is operable only to classify particles into types which are specific to control samples.

### Example 26

The method of any of examples 14-25, wherein the representation of the particle from the sample is an image of the particle from the sample.

### Example 27

The method of any of examples 14-26, wherein obtaining the representation of the particle from the sample comprises: using a flowcell to convey a portion of the sample comprising the particle through a viewing zone of the camera; and using the camera to capture to capture the image of the particle when the particle in the viewing zone of the camera.

### Example 28

The method of example 27, wherein using the flowcell to convey the portion of the sample through the viewing zone of the camera comprises enveloping the portion of the sample comprising the particle in sheath fluid which carries the particle in a flow stream through a narrowing zone of the flowcell to the viewing zone of the camera.

### Example 29

The method of any of examples 14-28, wherein the method comprises identifying the sample as a control sample based on the classification of the particle.

### Example 30

A non-transitory computer readable medium having stored thereon instructions operable to, when executed by a process, cause an analyzer to perform a method as claimed in any of claims 14-29.

Each of the calculations or operations described herein may be performed using a computer or other processor having hardware, software, and/or firmware. The various method steps may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like.

All patents, patent publications, patent applications, journal articles, books, technical references, and the like discussed in the instant disclosure are incorporated herein by reference in their entirety for all purposes.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention. Accordingly, the claims should not be treated as limited to the examples, drawings, embodiments and illustrations provided above, but instead should be understood as having the scope provided when their terms are given their broadest reasonable interpretation as provided by a general-purpose dictionary, except that when a term or phrase is indicated as having a particular meaning under the heading Explicit Definitions, it should be understood as having that meaning when used in the claims.

### Explicit Definitions

It should be understood that, in the above examples and the claims, a statement that something is “based on” something else should be understood to mean that it is determined at least in part by the thing that it is indicated as being based on. To indicate that something must be completely determined based on something else, it is described as being “based EXCLUSIVELY on” whatever it must be completely determined by.

It should be understood that, in the above examples and claims, the term “set” should be understood as one or more things which are grouped together.

1-13. (canceled)

14. A method for validating performance of an analyzer, the method comprising:
providing a sample to an analyzer, wherein the analyzer is adapted to use a camera in analyzing samples;
obtaining a representation of a particle from the sample; and
obtaining a classification of the particle, wherein the classification classifies the particle as a type specific to control samples.

15. The method of claim 14, wherein the method comprises:
performing control specific processing on the sample; and
generating an analysis output for the sample, wherein the analysis output is based on a result of the control specific processing, and the analysis output includes a number of particles of the sample.

16. The method of claim 15, wherein:
the control specific processing comprises, based on the classification of the particle, obtaining a second classification of the particle;
the second classification of the particle is a classification as a type which is not specific to control samples; and
generating the analysis output for the sample comprises generating the analysis output based on the second classification of the particle.

17. The method of claim 16, wherein:
the type which is specific to control samples is a synthetic particle type; and
the type which is not specific to control samples is a blood cell type.

18. The method of claim 17, wherein the blood cell type is selected from:
neutrophils;
lymphocytes;
monocytes;
eosinophils; and
basophils.

19. The method of claim 17, wherein the blood cell type is selected from:
red blood cells;
nucleated red blood cells;
reticulocytes; and
platelets.

20. The method of claim 15, wherein the analysis output is selected from: a five-part differential output, a six part differential output, and a seven part differential output.

21. The method of claim 14, wherein the sample comprises the particle in a carrier fluid.

22. The method of claim 21, wherein said particle is configured to represent a blood cell type.

23. The method of claim 21, wherein said particle comprises one or more detectable features selected from size, light reflecting property, color, surface detection pattern, internal structures and surface functionalization.

24. The method of claim 15, wherein:
obtaining the classification of the particle is performed using a first classifier, wherein the first classifier is configured to classify particles from control samples into types specific to control samples and to classify particles from patient samples into types which are not specific to control samples;
the method comprises:
for each of a plurality of additional particles from the sample:
obtaining a representation of that particle; and
obtaining a classification of that particle using the first classifier; and
determining that the sample is a control sample based on a majority of classifications obtained for particles from the sample classifying those particles into types specific to control samples;
and
the control specific processing is performed on the sample based on determining that the sample is a control sample.

25. The method of claim 15, wherein the control specific processing comprises classifying a set of representations of particles from the sample using a classifier which is operable only to classify particles into types which are specific to control samples.

26. The method of claim 14, wherein the representation of the particle from the sample is an image of the particle from the sample.

27. The method of claim 14, wherein obtaining the representation of the particle from the sample comprises:
using a flowcell to convey a portion of the sample comprising the particle through a viewing zone of the camera; and
using the camera to capture to capture the image of the particle when the particle in the viewing zone of the camera.

28. The method of claim 27, wherein using the flowcell to convey the portion of the sample through the viewing zone of the camera comprises enveloping the portion of the sample comprising the particle in sheath fluid which carries the particle in a flow stream through a narrowing zone of the flowcell to the viewing zone of the camera.

29. The method of claim 14, wherein the method comprises identifying the sample as a control sample based on the classification of the particle.

30. (canceled)

31. A system for cell classification comprising:
a camera;
a processor; and
a non-transitory computer readable medium having stored thereon instructions operable to, when executed by the processor, perform a set of acts comprising:
obtaining a representation of a particle from a sample; and
obtaining a classification of the particle, wherein the classification classifies the particle as a type specific to control samples.

32. The system of claim 31, wherein:
obtaining the classification of the particle is performed using a first classifier, wherein the first classifier is configured to classify particles from control samples into types specific to control samples and to classify particles from patient samples into types which are not specific to control samples;
the set of acts comprises:
for each of a plurality of additional particles from the sample:
obtaining a representation of that particle; and
obtaining a classification of that particle using the first classifier;
and
determining that the sample is a control sample based on a majority of classifications obtained for particles from the sample classifying those particles into types specific to control samples;
and
the control specific processing is performed on the sample based on determining that the sample is a control sample.

33. The system of claim 31, wherein the set of acts comprises identifying the sample as a control sample based on the classification of the particle.

34. The system of claim 31, wherein the set of acts comprises:
performing control specific processing on the sample; and
generating an analysis output for the sample, wherein the analysis output is based on a result of the control specific processing, and the analysis output includes a number of particles of the sample.
